(19) United States
(12) Patent Application Publication
(10) Pub. No.: US 2024/0037410 A1
(43) Pub. Date: Feb. 1, 2024

(54) METHOD FOR MODEL AGGREGATION IN FEDERATED LEARNING, SERVER, DEVICE, AND STORAGE MEDIUM

(71) Applicant: BEIJING BAIDU NETCOM SCIENCE TECHNOLOGY CO., LTD., Beijing (CA)

(72) Inventors: Ji LIU, Beijing (CN); Beichen MA, Beijing (CN); Dejing DOU, Beijing (CN)

(73) Assignee: BEIJING BAIDU NETCOM SCIENCE TECHNOLOGY CO., LTD., Beijing (CN)

(21) Appl. No.: 18/108,977

(22) Filed: Feb. 13, 2023

(30) Foreign Application Priority Data
Jul. 26, 2022 (CN) 202210882382.X

(51) Int. Cl. G06N 3/098

(52) U.S. Cl. CPC G06N 3/098

(57) ABSTRACT

A method for model aggregation in federated learning (FL), a server, a device, and a storage medium are suggested, which relate to the field of artificial intelligence (AI) technologies such as machine learning. A specific implementation solution involves: acquiring a data not identically and independently distributed (Non-IID) degree value of each of a plurality of edge devices participating in FL; acquiring local models uploaded by the edge devices; and performing aggregation based on the data Non-IID degree values of the edge devices and the local models uploaded by the edge devices to obtain a global model.

### CROSS-REFERENCE TO RELATED APPLICATION

The present application claims the priority of Chinese Patent Application No. 202210882382.X, filed on Jul. 26, 2022, with the title of “METHOD FOR MODEL AGGREGATION IN FEDERATED LEARNING, SERVER, DEVICE, AND STORAGE MEDIUM.” The disclosure of the above application is incorporated herein by reference in its entirety.

### FIELD OF THE DISCLOSURE

The present disclosure relates to the field of computer technologies, specifically to the field of artificial intelligence (AI) technologies such as machine learning, and in particular, to a method for model aggregation in federated learning (FL), a server, a device, and a storage medium.

### BACKGROUND OF THE DISCLOSURE

With the rapid development of AI technologies, a deep learning technology, as one of the most important technologies, is required to be based on a very large amount of data. In addition, various existing edge devices, such as smart phones, smart tablets, and smart watches, collect a large amount of data while being convenient to operate, which is very attractive for the deep learning technology. In conventional machine learning technologies, data is collected from edge devices and then trained in a centralized manner, which poses a huge threat to privacy of the data on the edge devices.

Federated learning (FL) is a distributed machine learning technology. Unlike previous machine learning technologies, FL does not require collecting data from users on the edge devices, but keeps the data locally. Models are trained locally at edge devices selected by a central server, and the edge devices upload the trained models to the central server. Then, the central server aggregates the models uploaded by the edge devices to obtain a global model. In this manner, the data does not leave locally, which can effectively protect users' data privacy security.

### SUMMARY OF THE DISCLOSURE

The present disclosure provides a method for model aggregation in FL, a server, a device, and a storage medium.

According to an aspect of the present disclosure, a method for model aggregation in FL is provided. The method includes acquiring a data not identically and independently distributed (Non-IID) degree value of each of a plurality of edge devices participating in FL; acquiring local models uploaded by the edge devices; and performing aggregation based on the data Non-IID degree values of the edge devices and the local models uploaded by the edge devices to obtain a global model.

According to another aspect of the present disclosure, there is provided an electronic device, including at least one processor; and a memory communicatively connected with the at least one processor; wherein the memory stores instructions executable by the at least one processor, and the instructions are executed by the at least one processor to enable the at least one processor to perform a method for model aggregation in federated learning (FL), wherein the method includes acquiring a data Non-IID degree value of each of a plurality of edge devices participating in FL; acquiring local models uploaded by the edge devices; and performing aggregation based on the data Non-IID degree values of the edge devices and the local models uploaded by the edge devices to obtain a global model.

According to still another aspect of the present disclosure, there is provided a non-transitory computer readable storage medium with computer instructions stored thereon, wherein the computer instructions are used for causing a method for model aggregation in federated learning (FL), wherein the method includes acquiring a data not identically and independently distributed (Non-IID) degree value of each of a plurality of edge devices participating in FL; acquiring local models uploaded by the edge devices; and performing aggregation based on the data Non-IID degree values of the edge devices and the local models uploaded by the edge devices to obtain a global model.

It should be understood that the content described in this part is neither intended to identify key or significant features of the embodiments of the present disclosure, nor intended to limit the scope of the present disclosure. Other features of the present disclosure will be made easier to understand through the following description.

### BRIEF DESCRIPTION OF DRAWINGS

The accompanying drawings are intended to provide a better understanding of the solutions and do not constitute a limitation on the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a block diagram of an electronic device configured to implement a method according to an embodiment of the present disclosure; and

FIG. 6 shows formulas described in the present disclosure.

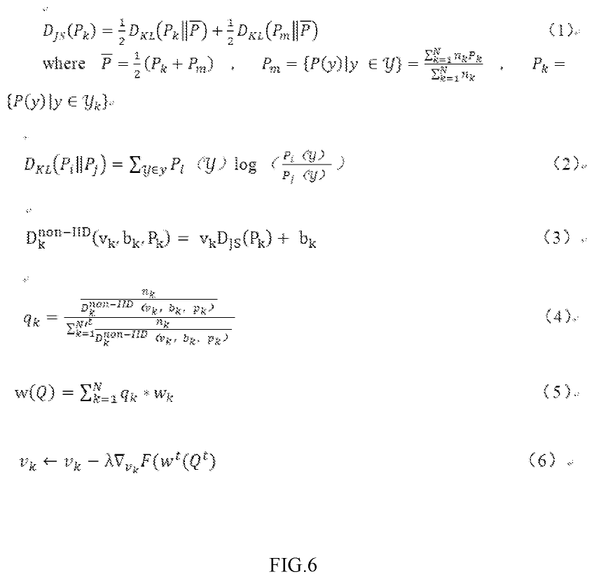

### DETAILED DESCRIPTION OF PREFERRED EMBODIMENTS

Exemplary embodiments of the present disclosure are illustrated below with reference to the accompanying drawings, which include various details of the embodiments of the present disclosure to facilitate understanding and should be considered only as exemplary. Therefore, those of ordinary skill in the art should be aware that various changes and modifications can be made to the embodiments described herein without departing from the scope and spirit of the present disclosure. Similarly, for clarity and simplicity, descriptions of well-known functions and structures are omitted in the following description.

Obviously, the embodiments described are some of rather than all of the embodiments of the present disclosure. All other embodiments acquired by those of ordinary skill in the art without creative efforts based on the embodiments of the present disclosure fall within the protection scope of the present disclosure.

It is to be noted that the terminal device involved in the embodiments of the present disclosure may include, but is not limited to, smart devices such as mobile phones, personal digital assistants (PDAs), wireless handheld devices, and tablet computers. The display device may include, but is not limited to, devices with a display function such as personal computers and televisions.

In addition, the term “and/or” herein is merely an association relationship describing associated objects, indicating that three relationships may exist. For example, A and/or B indicates that there are three cases of A alone, A and B together, and B alone. Besides, the character “/” herein generally means that associated objects before and after it are in an “or” relationship.

In Federated learning (FL), a central server may coordinate training of edge devices in multiple rounds. The following steps may be included in each round. In the first step, the central server first sends models to selected edge devices. In the second step, the selected edge devices update the models with local data and upload updated models to the central server. In the third step, the central server aggregates the models uploaded by the edge devices to obtain a global model. For example, during the aggregation, the central server may aggregate the models uploaded by the edge devices based on sizes of data sets on the edge devices. A global model where a loss function converges can be obtained through multiple rounds of training in the above manner.

In the prior art, in the aggregation method in each round of the central server, only the influence of sizes of local data sets of the edge devices on the global model after aggregation is considered. However, in practical applications, data sets on different edge devices not only have different sizes, but may also be distributed differently. For example, label data in data sets included on different edge devices may be distributed differently. However, the central server of the prior art does not consider data distribution of the edge devices during the aggregation, which inevitably leads to low precision of the global model obtained by aggregation and seriously affects accuracy of the trained global model.

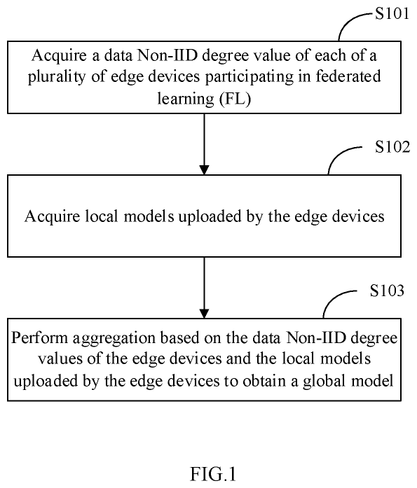

FIG. 1 is a schematic diagram according to a first embodiment of the present disclosure. As shown in FIG. 1, this embodiment provides a method for model aggregation in FL applied to a central server for FL. The method may specifically include the following steps.

In S101, a data Non-IID degree value of each of a plurality of edge devices participating in FL is acquired.

In S102, local models uploaded by the edge devices are acquired.

In S103, aggregation is performed based on the data Non-IID degree values of the edge devices and the local models uploaded by the edge devices to obtain a global model.

In this embodiment, the global model and the local models refer to models when a same model corresponds to different parameter values in different stages. The global model refers to a model with unified global parameter values obtained by the central server after the aggregation on the side of the central server. The local models refer to models which are trained by the edge devices based on the local data sets to obtain the corresponding local parameter values on the side of the edge devices.

In FL, the data sets on the edge devices may not only have different storage sizes, but may also be distributed differently. In consideration of this, in this embodiment, Non-IID degree values are introduced. The Non-IID degree value of each edge device can identify data distribution information of the edge device relative to all edge devices participating in FL. Specifically, it may be considered that the Non-IID degree value of each edge device is a quantitative value of a difference between distribution of the data set on the edge device and distribution of all the data sets on all the edge devices participating in the training. The higher the Non-IID degree value, the more obvious the difference between data distribution of the current edge device and all edge devices participating in FL, and vice versa.

The technical solution of this embodiment is applicable to every round of training in FL. In each round of training of FL, only some edge devices can be selected to participate in FL. For example, a preset percentage of edge devices can be randomly selected from all edge devices to participate in a round of training. Edge devices selected in two consecutive rounds may be the same or different.

In each round of training, the central server, after determining the global model, may send the global model to each edge device participating in this round of FL. For example, specifically, global parameter values of parameters of the global model may be sent to the edge devices participating in this round of FL, so as to realize the sending of the global model to the edge devices. In the first round of training, the global parameter values of the parameters of the global model may be obtained by random initialization for the central server. In other rounds of training, the global parameter values of the parameters of the global model may be obtained by the central server by aggregating the local models uploaded by the edge devices during a previous round of training. Each edge device receives a same global model sent by the central server in each round of training. Then, based on the received global model, the edge devices use the local data sets to continue to train the global model. Due to different data sets on the edge devices, the local parameter values of the parameters of the local models obtained after local training on the edge devices are also different. After completion of each round of training, the edge devices upload the local models obtained in this round of training to the central server. Specifically, the edge devices upload the local parameter values of the parameters of the local models to the central server to upload the local models to the central server.

Finally, the central server performs aggregation based on the data Non-IID degree values of the edge devices and the local models uploaded by the edge devices to obtain a global model. The models in this embodiment are machine learning models, that is, models of a neural network structure. One model may include a large number of parameters. For each parameter in the models, the central server may perform parameter aggregation based on the data Non-IID degree value of the edge device and a local parameter value of the parameter of the local model uploaded by the edge device to obtain a global parameter value of the parameter of the global model. In the above manner, the global parameter value corresponding to each parameter in the global model can be obtained by aggregation, and then the global model can be obtained.

In other words, in this embodiment, the global model and the local models are products of a same model on the side of the central server and the side of the edge devices. For a same parameter, a corresponding parameter value in the global model is the global parameter value, and a corresponding parameter value in the local model is the local parameter value. A unified model obtained after the aggregation by the central server is the global model. A model sent by the central server to the edge devices participating in FL is the global model. Models obtained after the edge devices use the local data sets for training based on the received global model are the local models. That is, when the edge devices perform local training, the global parameter values of the parameters of the global model are updated to obtain the corresponding local parameter values.

According to the method for model aggregation in FL in this embodiment, aggregation is performed through the Non-IID degree values of the edge devices participating in FL and the local models uploaded by the edge devices to obtain the global model. Since the Non-IID degree values of the edge devices can identify data distribution information of the edge device relative to all edge devices participating in FL, in the aggregation manner, the local models can be aggregated more reasonably and more accurately, and then precision of the global model obtained by aggregation can be effectively improved, so as to obtain a more accurate global model. Therefore, according to the technology of the present disclosure, accuracy of the models obtained in FL can be effectively improved.

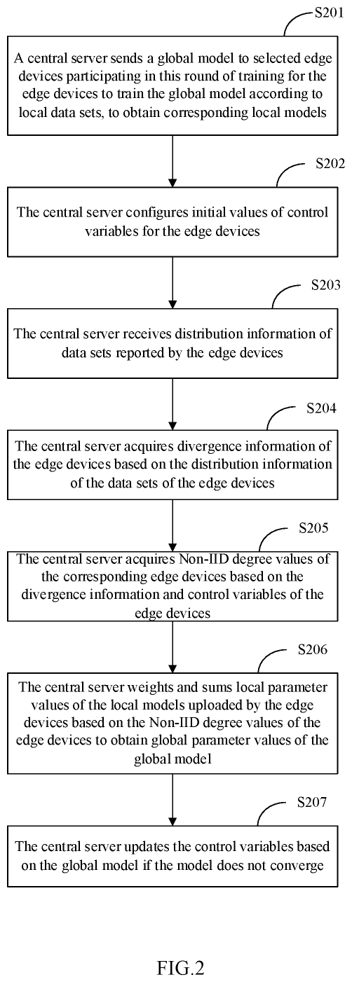

FIG. 2 is a schematic diagram according to a second embodiment of the present disclosure. As shown in FIG. 2, this embodiment provides a method for model aggregation in FL, and introduces the technical solution of the present disclosure in further detail on the basis of the technical solution in the embodiment shown in FIG. 1. As shown in FIG. 2, in this embodiment, the method may specifically include the following steps.

In S201, a central server sends a global model to selected edge devices participating in this round of training for the edge devices to train the global model according to local data sets, to obtain corresponding local models.

In specific implementation, the central server sends global parameter values of parameters of the global model to the edge devices participating in this round of training, so as to realize the sending of the global model to the edge devices.

Correspondingly, the edge devices, after receiving the global model, train the global model according to the local data sets, and update the global parameter values of the parameters in the global model to obtain the local parameter values of the parameters and then obtain the local models of the corresponding edge devices.

In S202, the central server configures initial values of control variables for the edge devices.

In this embodiment, different from model parameters, the control variables do not change with the global parameter values or the local parameter values of the model, but are variables configured to control model training. In practical applications, there may be one, two or more control variables. In this embodiment, same initial values of the control variables may be configured for the edge devices, and of course, different initial values of the control variables may be configured for the edge devices.

In S203, the central server receives distribution information of data sets reported by the edge devices.

It is to be noted that step S203 may be performed after the edge devices receive the global model sent by the central server, that is, after step 201, and is not required to be performed after the edge devices train the global model locally to obtain the local models. Certainly, such information may also be uploaded together with the local models to the central server after the edge devices obtain the local models by training.

In S204, the central server acquires divergence information of the edge devices based on the distribution information of the data sets of the edge devices.

For example, the divergence information of the edge devices in this embodiment may be Jensen-Shannon (JS for short) divergence.

For example, JS divergence D_{JS}(Pₖ) of a k^{th} edge device may be expressed by the following formula:

D_{JS}(Pₖ)=½D_{KL}(Pₖ∥P̅)+½D_{KL}(Pₘ∥P̅) (1)

where

$$\overline{P} = \frac{1}{2} ( {P}_{k} + {P}_{m} ) , {P}_{m} = \{ P ( y ) \vert y ∈ \} = \frac{{\sum }_{k = 1}^{N} {n}_{k} {P}_{k}}{{\sum }_{k = 1}^{N} {n}_{k}} ,$$

and Pₖ={P(y)|y∈ [symbol] ₖ}, where nₖ denotes a number of samples of the k^{th} device, N denotes a number of edge devices participating in FL, [symbol] denotes a label set in an entire data set, [symbol] ₖ denotes a label set of a data set Dₖ on the k^{th} edge device, and P(y) denotes data distribution information of the corresponding data set Dₖ. [symbol] (⋅∥⋅)denotes Kullback-Leibler (KL for short) divergence, which may be expressed by the following formula:

$${D}_{KL} ( {P}_{i} ‖ {P}_{j} ) = {\sum }_{∈ y} {P}_{i} ( ) log ( \frac{{P}_{i} ( )}{{P}_{j} ( )} ) \qquad ( 2 )$$

In S205, the central server acquires Non-IID degree values of the corresponding edge devices based on the divergence information and control variables of the edge devices.

Although the JS divergence or the KL divergence is generally used to identify a non-IID degree value, a difference still exists between the JS divergence or the KL divergence and the non-IID degree value. In this embodiment, the JS divergence and the control variables of the edge devices can be used together to identify the Non-IID degree values, so that the Non-IID degree values of the edge devices are more reasonable and more accurate, and then more accurate model aggregation can be performed, so as to obtain more accurate global parameters of the models.

For example, in this embodiment, two control variables and divergence information can be used together to identify the Non-IID degree value. For example, for the k^{th} edge device, two corresponding control variables are vₖ and vₖ respectively, and the Non-IID degree value Dₖ^{non-IID}(vₖ, bₖ, Pₖ) of the k^{th} edge device may be expressed as:

Dₖ^{non-IID}(vₖ, bₖ, Pₖ)=vₖD_{JS}(Pₖ)+bₖ (3)

In practical applications, only one control variable or more control variables may be combined with vₖD_{JS}(Pₖ) to identify the Non-IID degree value together mathematically, which is not limited herein.

In S206, the central server weights and sums local parameter values of the local models uploaded by the edge devices based on the Non-IID degree values of the edge devices to obtain global parameter values of the global model.

For example, in specific implementation of the step, weights of the edge devices may be acquired first based on the Non-IID degree values of the edge devices. For example, the weight of the k^{th} edge device may be expressed as:

$${q}_{k} = \frac{\frac{{n}_{k}}{{D}_{k}^{non - IID} ( {v}_{k} , {b}_{k} , {p}_{k} )}}{{\sum }_{k = 1}^{N {′}^{t}} \frac{{n}_{k}}{{D}_{k}^{non - IID} ( {v}_{k} , {b}_{k} , {p}_{k} )}} \qquad ( 4 )$$

where N′^{t} denotes a number of selected edge devices participating in FL in a t^{th} round of training, nₖ denotes a number of data included in the data set of the k^{th} edge device, qₖ∈Q^{t}, ∀k∈{1, . . . , N}, and Q^{t} denotes a weight set.

Then, local parameter values of parameters of the local models uploaded by the edge devices are weighted and summed based on the weights of the edge devices to obtain global parameter values of parameters of the global model, so as to obtain the global model. For example, for any parameter in the models, the local parameter value of the parameter in the local model uploaded by each of all the edge devices is multiplied by the weight of the edge device and then summed as the global parameter value of the parameter in the global model. In this manner, the global parameter value of each parameter in the global model after aggregation can be obtained, and then the global model can be obtained.

For example, the global parameter value w(Q) of each parameter in the global model may be expressed by the following formula:

w(Q)=Σₖ₌₁^{N}qₖ*wₖ (5)

where N denotes a number of edge devices participating in FL, wₖ denotes the local parameter value of the parameter reported by the k^{th} edge device, and qₖ denotes the weight of the k^{th} edge device, which is calculated by using the formula (4) based on the Non-IID degree values of the edge devices. N in the formula (5) denotes a number of all edge devices participating in FL, including the edge devices participating in this round of training as well as edge devices not participating in this round of training, but qₖ of the edge devices not participating in this round of training is equal to 0.

If the model converges upon detection, when the training is terminated, the global parameter values of the parameters of the global model after aggregation are taken as final values, and the global model can be determined in this case. If the model does not converge, further training is required in this case, and the control variables of the edge devices are updated to facilitate the aggregation of the model in next round of training. In this case, the following step S207 may be specifically included.

In S207, the central server updates the control variables based on the global model if the model does not converge.

For example, in this embodiment, in specific update, the following steps may be adopted for implementation.
(1) Partial derivative values of the control variables with respect to the global model are acquired.
In other words, partial derivatives of the control variables are calculated by using the global model, to obtain the partial derivative values of the control variables with respect to the global model.
(2) The control variables are updated based on the partial derivative values, a preset learning rate, and the control variables.

In this embodiment, the preset learning rate is a dynamically changing process. For example, with the continuous progress of learning, the value of the learning rate becomes smaller and smaller.

During the training of FL, the global parameters and the control variables of the models are required to be iteratively updated. In particular, a random gradient descent method may be used for update and iteration. For example, update of the control variables may be expressed by the following formula:

vₖ←vₖ−λ∇ᵥ_{ₖ}F(w^{t}(Q^{t}) (6)

λ denotes the learning rate, ∇ᵥ_{ₖ}F(w^{t}(Q^{t}) denotes a partial derivative of a control variable vₖ with respect to a global model F(w^{t}(Q^{t})).

Referring to the formula

$${q}_{k}^{t} = \frac{\frac{{n}_{k}}{{D}_{k}^{non - IID} ( {v}_{k}^{t} , {b}_{k}^{t} , {p}_{k} )}}{{\sum }_{k = 1}^{N {′}^{t}} \frac{{n}_{k}}{{D}_{k}^{non - IID} ( {v}_{k}^{t} , {b}_{k}^{t} , {p}_{k} )}} \qquad ( 4 )$$

qₖ^{t}∈Q^{t}, and ∀k∈{1, . . . ,N}. During the training, ∇ᵥ_{ₖ}_{^{t}}F(w^{t}(Q^{t})) is calculated only according to selected N′^{t} edge devices in this round of training instead of all the edge devices.

In addition, the principle of update of the control variable bₖ^{t} is the same as that of the above vₖ^{t}. Details are not described herein again. In this embodiment, the control variables of the edge devices are stored and maintained in the central server.

When the model does not converge, step S201 is performed to continue next round of training, and the central server sends global parameter values of the global model to selected edge devices participating in this round of training for the edge devices to train the global model according to the local data sets to obtain local parameter values of the corresponding local models. Then, step S203 is performed until the global model converges, and the training is terminated. In this case, the global parameter values of the global model are obtained, that is, a global model finally learned by FL is obtained.

The aggregated models in FL in this embodiment may be CNN, Lenet, Vgg, Alexnet, Resnet, and other neural network models. The models may specifically be task processing models in various task scenarios, such as an image recognition model and an object detection model, which are not be illustrated one by one herein.

According to the method for model aggregation in FL in this embodiment, in the above manner, the control variables of the edge devices can be effectively updated in each round of training, so that more accurate Non-IID degree values can be obtained in each round of training. Moreover, during aggregation, aggregation is performed according to the Non-IID degree values of the edge devices participating in FL and the local models uploaded by the edge devices to obtain a more accurate global model, the local models can be aggregated more reasonably and more accurately, and precision of the global model obtained by aggregation can be effectively improved, so as to obtain a more accurate global model. Therefore, according to the technology of the present disclosure, accuracy of the models obtained in FL can be effectively improved.

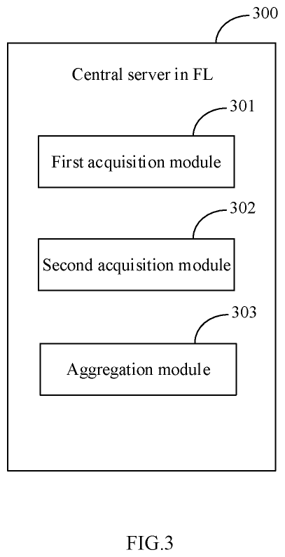

FIG. 3 is a schematic diagram according to a third embodiment of the present disclosure. As shown in FIG. 3, this embodiment provides a central server 300 in FL, including: a first acquisition module 301 configured to acquire a data Non-IID degree value of each of a plurality of edge devices participating in FL; a second acquisition module 302 configured to acquire local models uploaded by the edge devices; and an aggregation module 303 configured to perform aggregation based on the data Non-IID degree values of the edge devices and the local models uploaded by the edge devices to obtain a global model.

An implementation principle and a technical effect of the central server 300 in this embodiment realizing FL by using the above modules are the same as those in the above related method embodiment. Details may be obtained with reference to the description in the above related method embodiment, and are not described herein.

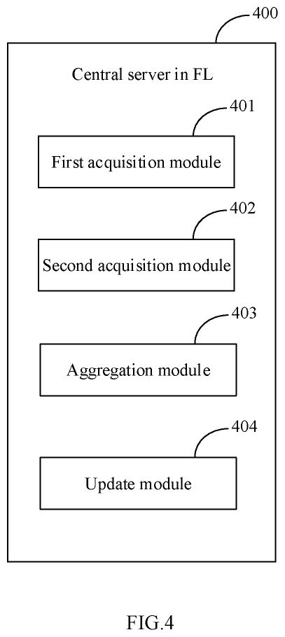

FIG. 4 is a schematic diagram according to a fourth embodiment of the present disclosure. As shown in FIG. 4, this embodiment provides a central server 400 in FL, including the modules with same names and same functions as shown in FIG. 3, i.e., a first acquisition module 401, a second acquisition module 402, and an aggregation module 403.

In the central server 400 in FL in this embodiment, the first acquisition module 401 is configured to: receive distribution information of data sets reported by the edge devices; acquire divergence information of the edge devices based on the distribution information of the data sets of the edge devices; and acquire the data Non-IID degree values of the corresponding edge devices based on the divergence information and control variables of the edge devices.

As shown in FIG. 4, in an embodiment of the present disclosure, the central server 400 in FL further includes an update module 404 configured to update the control variables based on the global model.

Further optionally, the update module 404 is configured to acquire partial derivative values of the control variables with respect to the global model; and update the control variables based on the partial derivative values, a preset learning rate, and the control variables.

Further optionally, the aggregation module 403 is configured to weight and sum local parameter values of the local models uploaded by the edge devices based on the data Non-IID degree values of the edge devices to obtain global parameter values of the global model, so as to obtain the global model.

Further optionally, the aggregation module 403 is configured to acquire weights of the edge devices based on the data Non-IID degree values of the edge devices; and weight and sum local parameter values of parameters of the local models uploaded by the edge devices based on the weights of the edge devices to obtain global parameter values of parameters of the global model, so as to obtain the global model.

An implementation principle and a technical effect of the central server 300 in this embodiment realizing FL by using the above modules are the same as those in the above related method embodiment. Details may be obtained with reference to the description in the above related method embodiment, and are not described herein.

Acquisition, storage, and application of users' personal information involved in the technical solutions of the present disclosure comply with relevant laws and regulations, and do not violate public order and moral.

According to embodiments of the present disclosure, the present disclosure further provides an electronic device, a readable storage medium, and a computer program product.

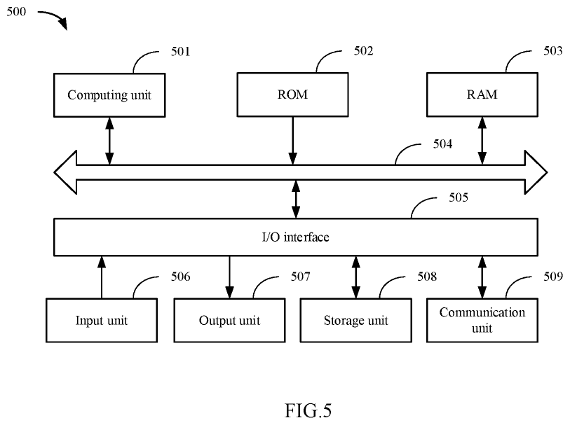

FIG. 5 is a schematic block diagram of an example electronic device 500 that may be configured to implement an embodiment of the present disclosure. The electronic device is intended to represent various forms of digital computers, such as laptops, desktops, workbenches, PDAs, servers, blade servers, mainframe computers and other suitable computers. The electronic device may further represent various forms of mobile devices, such as PDAs, cellular phones, smart phones, wearable devices and other similar computing devices. The components, their connections and relationships, and their functions shown herein are examples only, and are not intended to limit the implementation of the present disclosure as described and/or required herein.

As shown in FIG. 5, the device 500 includes a computing unit 501, which may perform various suitable actions and processing according to a computer program stored in a read-only memory (ROM) 502 or a computer program loaded from a storage unit 508 into a random access memory (RAM) 503. The RAM 503 may also store various programs and data required to operate the device 500. The computing unit 501, the ROM 502, and the RAM 503 are connected to one another by a bus 504. An input/output (I/O) interface 505 is also connected to the bus 504.

A plurality of components in the device 500 are connected to the I/O interface 505, including an input unit 506, such as a keyboard and a mouse; an output unit 507, such as various displays and speakers; a storage unit 508, such as disks and discs; and a communication unit 509, such as a network card, a modem and a wireless communication transceiver. The communication unit 509 allows the device 500 to exchange information/data with other devices over computer networks such as the Internet and/or various telecommunications networks.

The computing unit 501 may be a variety of general-purpose and/or special-purpose processing components with processing and computing capabilities. Some examples of the computing unit 501 include, but are not limited to, a central processing unit (CPU), a graphics processing unit (GPU), various AI computing chips, various computing units that run machine learning model algorithms, a digital signal processor (DSP), and any appropriate processor, controller or microcontroller, etc. The computing unit 501 performs the methods and processing described above, such as the method in the present disclosure. For example, in some embodiments, the method in the present disclosure may be implemented as a computer software program that is tangibly embodied in a machine-readable medium, such as the storage unit 508. In some embodiments, part or all of a computer program may be loaded and/or installed on the device 500 via the ROM 502 and/or the communication unit 509. One or more steps of the method in the present disclosure described above may be performed when the computer program is loaded into the RAM 503 and executed by the computing unit 501. Alternatively, in other embodiments, the computing unit 501 may be configured to perform the method in the present disclosure by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a complex programmable logic device (CPLD), computer hardware, firmware, software, and/or combinations thereof. Such implementations may include implementation in one or more computer programs that are executable and/or interpretable on a programmable system including at least one programmable processor, which can be special or general purpose, configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or another programmable data processing apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, the machine-readable medium may be tangible media which may include or store programs for use by or in conjunction with an instruction execution system, apparatus or device. The machine-readable medium may be a machine-readable signal medium or machine-readable storage medium. The machine-readable medium may include, but is not limited to, an electronic, magnetic, optical, electromagnetic, infrared, or semiconductor system, apparatus or device, or any suitable combinations thereof. More specific examples of a machine-readable storage medium may include electrical connections based on one or more wires, a portable computer disk, a hard disk, an RAM, an ROM, an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, speech input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN), and the Internet.

The computer system may include a client and a server. The client and the server are generally far away from each other and generally interact via the communication network. A relationship between the client and the server is generated through computer programs that run on a corresponding computer and have a client-server relationship with each other. The server may be a cloud server, a distributed system server, or a server combined with blockchain.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above specific implementations do not limit the scope of protection of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the scope of protection of the present disclosure.

What is claimed is:

1. A method for model aggregation in federated learning (FL), comprising:
acquiring a data not identically and independently distributed (Non-IID) degree value of each of a plurality of edge devices participating in FL;
acquiring local models uploaded by the edge devices; and
performing aggregation based on the data Non-IID degree values of the edge devices and the local models uploaded by the edge devices to obtain a global model.

2. The method according to claim 1, wherein the acquiring a data Non-IID degree value of each of a plurality of edge devices participating in FL comprises:
receiving distribution information of data sets reported by the edge devices;
acquiring divergence information of the edge devices based on the distribution information of the data sets of the edge devices; and
acquiring the data Non-IID degree values of the corresponding edge devices based on the divergence information and control variables of the edge devices.

3. The method according to claim 2, wherein the method further comprises:
updating the control variables based on the global model.

4. The method according to claim 3, wherein the updating the control variables based on the global model comprises:
acquiring partial derivative values of the control variables with respect to the global model; and
updating the control variables based on the partial derivative values, a preset learning rate, and the control variables.

5. The method according to claim 1, wherein the performing aggregation based on the data Non-IID degree values of the edge devices and the local models uploaded by the edge devices to obtain a global model comprises:
weighting and summing local parameter values of the local models uploaded by the edge devices based on the data Non-IID degree values of the edge devices to obtain global parameter values of the global model, so as to obtain the global model.

6. The method according to claim 5, wherein the weighting and summing local parameter values of the local models uploaded by the edge devices based on the data Non-IID degree values of the edge devices to obtain global parameter values of the global model, so as to obtain the global model comprises:
acquiring weights of the edge devices based on the data Non-IID degree values of the edge devices; and
weighting and summing local parameter values of parameters of the local models uploaded by the edge devices based on the weights of the edge devices to obtain global parameter values of parameters of the global model, so as to obtain the global model.

7. The method according to claim 2, wherein the performing aggregation based on the data Non-IID degree values of the edge devices and the local models uploaded by the edge devices to obtain a global model comprises:
weighting and summing local parameter values of the local models uploaded by the edge devices based on the data Non-IID degree values of the edge devices to obtain global parameter values of the global model, so as to obtain the global model.

8. The method according to claim 3, wherein the performing aggregation based on the data Non-IID degree values of the edge devices and the local models uploaded by the edge devices to obtain a global model comprises:
weighting and summing local parameter values of the local models uploaded by the edge devices based on the data Non-IID degree values of the edge devices to obtain global parameter values of the global model, so as to obtain the global model.

9. The method according to claim 4, wherein the performing aggregation based on the data Non-IID degree values of the edge devices and the local models uploaded by the edge devices to obtain a global model comprises:
weighting and summing local parameter values of the local models uploaded by the edge devices based on the data Non-IID degree values of the edge devices to obtain global parameter values of the global model, so as to obtain the global model.

10. The method according to claim 7, wherein the weighting and summing local parameter values of the local models uploaded by the edge devices based on the data Non-IID degree values of the edge devices to obtain global parameter values of the global model, so as to obtain the global model comprises:
acquiring weights of the edge devices based on the data Non-IID degree values of the edge devices; and
weighting and summing local parameter values of parameters of the local models uploaded by the edge devices based on the weights of the edge devices to obtain global parameter values of parameters of the global model, so as to obtain the global model.

11. An electronic device, comprising:
at least one processor; and
a memory communicatively connected with the at least one processor;
wherein the memory stores instructions executable by the at least one processor, and the instructions are executed by the at least one processor to enable the at least one processor to perform a method for model aggregation in federated learning (FL), wherein the method comprises:
acquiring a data Non-IID degree value of each of a plurality of edge devices participating in FL;
acquiring local models uploaded by the edge devices; and
performing aggregation based on the data Non-IID degree values of the edge devices and the local models uploaded by the edge devices to obtain a global model.

12. The electronic device according to claim 11, wherein the acquiring a data Non-IID degree value of each of a plurality of edge devices participating in FL comprises:
receiving distribution information of data sets reported by the edge devices;
acquiring divergence information of the edge devices based on the distribution information of the data sets of the edge devices; and
acquiring the data Non-IID degree values of the corresponding edge devices based on the divergence information and control variables of the edge devices. comprises:

13. The electronic device according to claim 12, wherein the method further updating the control variables based on the global model.

14. The electronic device according to claim 13, wherein the updating the control variables based on the global model comprises:
acquiring partial derivative values of the control variables with respect to the global model; and
updating the control variables based on the partial derivative values, a preset learning rate, and the control variables.

15. The electronic device according to claim 11, wherein the performing aggregation based on the data Non-IID degree values of the edge devices and the local models uploaded by the edge devices to obtain a global model comprises:
weighting and summing local parameter values of the local models uploaded by the edge devices based on the data Non-IID degree values of the edge devices to obtain global parameter values of the global model, so as to obtain the global model.

16. The electronic device according to claim 15, wherein the weighting and summing local parameter values of the local models uploaded by the edge devices based on the data Non-IID degree values of the edge devices to obtain global parameter values of the global model, so as to obtain the global model comprises:
acquiring weights of the edge devices based on the data Non-IID degree values of the edge devices; and
weighting and summing local parameter values of parameters of the local models uploaded by the edge devices based on the weights of the edge devices to obtain global parameter values of parameters of the global model, so as to obtain the global model.

17. The electronic device according to claim 12, wherein the performing aggregation based on the data Non-IID degree values of the edge devices and the local models uploaded by the edge devices to obtain a global model comprises:
weighting and summing local parameter values of the local models uploaded by the edge devices based on the data Non-IID degree values of the edge devices to obtain global parameter values of the global model, so as to obtain the global model.

18. The electronic device according to claim 13, wherein the performing aggregation based on the data Non-IID degree values of the edge devices and the local models uploaded by the edge devices to obtain a global model comprises:
weighting and summing local parameter values of the local models uploaded by the edge devices based on the data Non-IID degree values of the edge devices to obtain global parameter values of the global model, so as to obtain the global model.

19. The electronic device according to claim 14, wherein the performing aggregation based on the data Non-IID degree values of the edge devices and the local models uploaded by the edge devices to obtain a global model comprises:
weighting and summing local parameter values of the local models uploaded by the edge devices based on the data Non-IID degree values of the edge devices to obtain global parameter values of the global model, so as to obtain the global model.

20. A non-transitory computer readable storage medium with computer instructions stored thereon, wherein the computer instructions are used for causing a method for model aggregation in federated learning (FL), wherein the method comprises:
acquiring a data not identically and independently distributed (Non-IID) degree value of each of a plurality of edge devices participating in FL;
acquiring local models uploaded by the edge devices; and
performing aggregation based on the data Non-IID degree values of the edge devices and the local models uploaded by the edge devices to obtain a global model.
